(19) United States
(12) Patent Application Publication
(10) Pub. No.: US 2016/0328724 A1
(43) Pub. Date: Nov. 10, 2016

(54) SYSTEM AND METHOD FOR FORECASTING WITH SPARSE TIME PANEL SERIES USING DYNAMIC LINEAR MODELS

(71) Applicant: Wal-Mart Stores, Inc., Bentonville, AR (US)

(72) Inventors: Shubhankar Ray, Union City, CA (US); Abhay Jha, Burlingame, CA (US)

(21) Appl. No.: 14/705,456

(22) Filed: May 6, 2015

(51) Int. Cl. G06Q 30/02; G06Q 10/08

(52) U.S. Cl. CPC G06Q 30/0202; G06Q 10/087

(57) ABSTRACT

A system and method for forecasting sales is presented. A set of stock keeping units (SKUs) is received, then placed into a plurality of clusters of SKUs. A set of dynamic linear models and associated parameters are chosen to create a forecast for each cluster in the plurality of clusters of SKUs. A sequential learning algorithm is used to create a weighting of each dynamic linear model in the set of dynamic linear models. The weighting of each dynamic linear model is updated using a particle learning algorithm. The particle learning algorithm comprises performing a resampling the set of dynamic linear models using a set of weights, propagating a set of state vectors through the set of dynamic linear models based on the resampling, and performing a sampling to determine parameters for the set of dynamic linear models. Then a sales forecast is generated and inventory can be ordered. Other embodiments are also disclosed herein.

### TECHNICAL FIELD

This disclosure relates generally to forecasting, and relates more particularly to forecasting sales for a retail business.

### BACKGROUND

A retail business typically needs to stock items in a warehouse or store in order to sell the items. Storing too few of a particular item can be undesirable because if the item is sold out, then the retail business is not able to sell the item until it is in stock again. Storing too many of a particular item also can be undesirable because the amount of space in a warehouse or store is finite—storing too many of an item that does not sell takes away space from items that do sell. Therefore, it would be desirable to have a system that can more accurately forecast the sales of items for a retailer or distributor.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system;

FIG. 2 illustrates a representative block diagram of an example of the elements included in the circuit boards inside a chassis of the computer system of FIG. 1;

FIG. 3 is a flowchart illustrating the operation of a method of predicting sales behavior;

FIGS. 4A-4B illustrate an exemplary sales graph of a stock keeping unit; and

FIG. 5 is a block diagram illustrating a system capable of performing a method of predicting sales behavior.

For simplicity and clarity of illustration, the drawing figures illustrate the general manner of construction, and descriptions and details of well-known features and techniques might be omitted to avoid unnecessarily obscuring the present disclosure. Additionally, elements in the drawing figures are not necessarily drawn to scale. For example, the dimensions of some of the elements in the figures might be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but might include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

In one embodiment, a method can comprise: receiving a set of stock keeping units (SKUs); creating a plurality of clusters of SKUs from the set of SKUs; choosing a set of dynamic linear models and associated parameters to create a forecast for each cluster in the plurality of clusters of SKUs; using a sequential learning algorithm to create a weighting of each dynamic linear model in the set of dynamic linear models; periodically updating the weighting of each dynamic linear model using a particle learning algorithm; generating a sales forecast for each cluster of SKUs in the plurality of clusters of SKUs; and ordering inventory based on the sales forecast for each cluster of SKUs in the plurality of clusters of SKUs.

In one embodiment, a system can comprise: a user input device; a display device; one or more processing modules; and one or more non-transitory storage modules storing computing instructions configured to run on the one or more processing modules and perform the acts of: receiving a set of stock keeping units (SKUs); creating a plurality of clusters of SKUs from the set of SKUs; choosing a set of dynamic linear models and associated parameters to create a forecast for each cluster in the plurality of clusters of SKUs; using a sequential learning algorithm to create a weighting of each dynamic linear model in the set of dynamic linear models; periodically updating the weighting of each dynamic linear model using a particle learning algorithm; generating a sales forecast for each cluster of SKUs in the plurality of clusters of SKUs; and ordering inventory based on the sales forecast for each cluster of SKUs in the plurality of clusters of SKUs.

Further embodiments include at least one non-transitory memory storage module having computer instructions stored thereon executable by one or more processing modules to: receive a set of stock keeping units (SKUs); create a plurality of clusters of SKUs from the set of SKUs; choose a set of dynamic linear models and associated parameters to create a forecast for each cluster in the plurality of clusters of SKUs; use a sequential learning algorithm to create a weighting of each dynamic linear model in the set of dynamic linear models; periodically update the weighting of each dynamic linear model using a particle learning algorithm; generating a sales forecast for each cluster of SKUs in the plurality of clusters of SKUs; and order inventory based on the sales forecast for each cluster of SKUs in the plurality of clusters of SKUs.

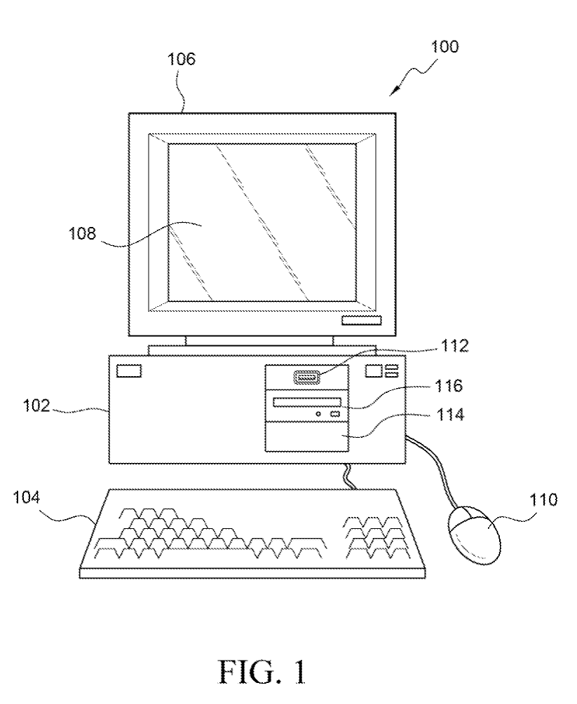

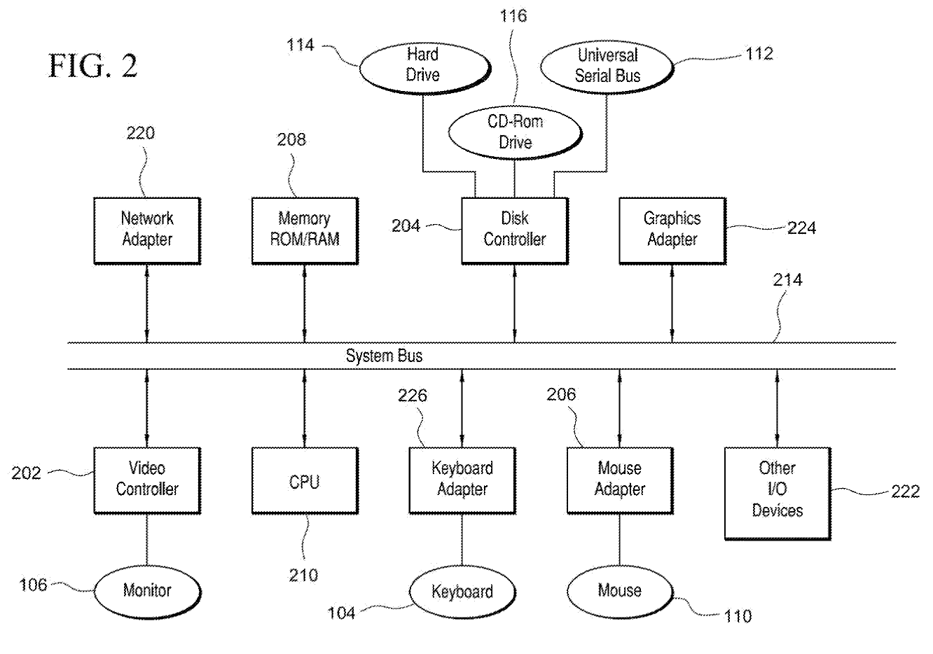

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a refreshing monitor 106, a keyboard 104, and/or a mouse 110, etc.) can also be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) volatile (e.g., transitory) memory, such as, for example, read only memory (ROM) and/or (ii) non-volatile (e.g., non-transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage module(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1-2), hard drive 114 (FIGS. 1-2), CD-ROM and/or DVD drive 116 (FIGS. 1-2), a floppy disk drive (not shown), an optical disc (not shown), a magneto-optical disc (now shown), magnetic tape (not shown), etc. Further, non-volatile or non-transitory memory storage module(s) refer to the portions of the memory storage module(s) that are non-volatile (e.g., non-transitory) memory.

In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Wash., United States of America, (ii) Mac® OS X by Apple Inc. of Cupertino, Calif., United States of America, (iii) UNIX® OS, and (iv) Linux® OS. Further exemplary operating systems can comprise one of the following: (i) the iOS® operating system by Apple Inc. of Cupertino, Calif., United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, Calif., United States of America, (v) the Windows Mobile™ operating system by Microsoft Corp. of Redmond, Wash., United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smart phone. In certain additional embodiments, computer system 100 may comprise an embedded system.

Forecasting is a key problem encountered in inventory planning for retailers and distributors. In order to buy inventory in advance, retailers or distributors would like an estimate of the number of units a distinct item for sale (also known as a stock keeping unit or a “SKU”) is going to sell in a certain time period. To clarify the difference between an item and a SKU, an item can be, for example, an iPad, but each specific configuration of the iPad (screen size, memory size, color, radio, and the like) is a different SKU. Each SKU typically has a unique identifier. Buying fewer quantities of a SKU than is needed leads to lost sales opportunities, hence lower revenue, because items that could have been sold were not in stock. Buying too many of a particular SKU units also can lead to lost sales opportunities because the cost of buying the unused inventory might not be compensated for by income from other sales to customers, and can lead to lost opportunity costs (e.g., items that do not sell occupying space in a warehouse or store in place of items that could have been sold).

In general, a retailer or distributor wants to forecast the number of units it will sell so it can accurately purchase the units on a timely basis. One method of forecasting examines past sales of an item. Past sales can reveal both local level and seasonal patterns. Local level patterns refer to sales in the recent past, as sales of a certain SKU in the recent past can be important in forecasting future sales. Seasonality refers to periodic events that can influence sales. Seasonality can refer both to general seasonality (e.g., sales might be higher during the autumn because of the holiday season), and to product seasonality (e.g., some products are generally used only during certain times of the year.) For example, swimwear might be more popular in the summer, while Christmas decorations are more popular in the fall and winter.

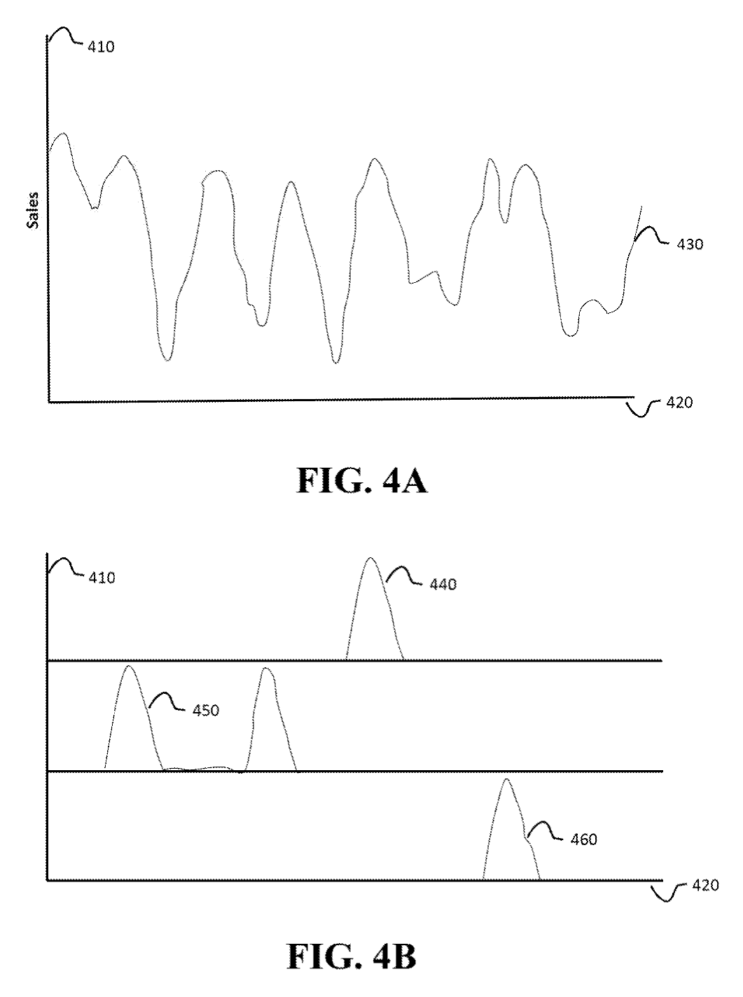

With reference to FIG. 4A, a graph illustrating the sales of an exemplary product is illustrated. X-axis 420 is the time period for the sales. For example, FIG. 4A could be an annual graph, and each time period is weekly sales. In another embodiment, FIG. 4A could be a multi-year graph, and each time period could be monthly sales. Other combinations are also possible.

Y-axis 410 is the range of values for sales. Data series 430 represents the sales for each time period represented by X-axis 420. Y-axis 410 can be in a variety of different formats. In some embodiments, Y-axis 410 can represent actual sales. In some embodiments, Y-axis 410 can represent sales rankings Using rankings as opposed to actual sales can result in more reliable and accurate data in some embodiments. For modeling purposes, two time-series can be considered similar if they rise and fall in unison. A rank correlation metric such as a Pearson correlation or a Spearman correlation can be used to measure similarity between time-series. For display purposes, Y-axis 410 can be linear or logarithmic.

As described above, a retailer would take data such as that illustrated in FIG. 4A and use the data to predict future sales. If the graph is relatively periodic, the retailer can forecast that more of the sales would occur during a certain time of the year and that fewer sales would occur during other times of the year. A few situations can occur that can make the use of such data to predict future sales difficult for some SKUs. For example, a possible situation can occur with electronic commerce (“eCommerce”) retailers. Because eCommerce retailers generally store more SKUs than brick and mortar stores, there might not be enough sales data to model each SKU separately. In addition, eCommerce retailers often stock SKUs that are short-lived or have erratic data. For example, some eCommerce retailers have SKUs that sell out quickly, and there exists a time period where there is no data. In addition, there are SKUs that are short-lived, and thus there might not be available seasonal data from a previous year. Exemplary short-lived SKUs can include clothing (because of fashion trends, some items of clothing are sold only for a single season) and electronics (some forms of electronics, such as cell phone and TVs, are updated regularly, so a particular SKU might not have existed a year ago.)

FIG. 4B illustrates three different SKUs that have such situations. The same X-axis 420 and Y-axis 410 that are present in FIG. 4A also are present in FIG. 4B. Data series 440, data series 450, and data series 460 represent the sales of three different items. Data series 440 has incomplete data. Sales are present only for a very short time period, with no sales before or after that time period. This type of data series can be indicative of a short-lived item. Because the item had sales for only a very short-period of time, a popular but short-lived item might be indicative of a product that is no longer made. Data series 450 has two sales spikes, with a period of zero or otherwise low sales in between the sales spikes. Such a data series might be indicative of an item that could not keep up with demand (between the two spikes), and is no longer being made. Or such a data series might be indicative of a seasonal item (explaining the sales spikes) that is no longer being made (explaining the lack of data after the second sales spike). Data series 460 is similar to data series 440 in that it has only a single spike. However, while data series 440 is similar to data series 430 in that a peak for data series 430 roughly coincides with a peak of data series 440, data series 460 has a peak that roughly coincides with a trough of data series 430. This fact can indicate both that the item in data series 460 is a short-lived item and that its sales do not correlate well with the item represented by data series 430. This type of behavior is discussed in further detail below.

One method of solving the above problems is to forecast items in groups (also known as clusters). In other words, instead of forecasting what each individual SKU will sell, one would place a SKU in a group with other SKUs. Then, one forecasts what the group of SKUs would sell. Data series 430, data series 440, and data series 450 could be forecast as a group. The forecast could then be used to order the proper number of items for each of the three SKUs. There are several different methods of and systems for grouping SKUs, both already existing and methods/systems developed by the present inventors. In some methods and systems, SKUs are grouped based on similarities in sales and semantics. Other methods can also be used to group SKUs.

Once the SKUs have been grouped, the group is modeled as a whole to create a forecast for all items in the group. Multivariate time series models can be used to model multiple items simultaneously, however, these models tend to define and estimate a lot of unknown parameters estimating which can be deteriorate the forecasting accuracy when there is a lot of missing data. To this end, multivariate dynamic linear models (MDLMs) can be used, which can be formulated on a group of a items with relatively small number of parameters. Let Yₜ=(y_{1,t}, y_{2,t}, . . . , y_{n,t})′ be the observed log of sales for all items in a group. Underlying these observations are unknown functions f(t)=(f₁(t),f₂(t), . . . , fₙ(t))′ representing the true demand of the grouped items. In other words, observing the unknown functions f(t) in noise gives rise to the observed sales Yₜ. Assuming the observational noise to be independent and identically distributed normal random variables leads to the following likelihood distribution for Yₜ:

Yₜ=f(t)+∈ₜ, ∈ₜ˜N(0, σ²Iₙ) or p(Yₜ|f(t))=N(f(t), σ²Iₙ).

where σ² is the observational noise variance. The MDLM can be specified by assuming that these unknown functions have additive contributions of local level components (i.e. local fluctuations) μₜ and and long-term seasonal components υ(t)αₜ. The likelihood then can be written as follows:

p(Yₜ|μₜ, αₜ)=N(μₜ+υ(t)αₜ, σ₂Iₙ).

Here υ(t) is a periodic function (i.e. for weekly time series with annual seasonal structure υ(t)=υ(t+52) for all t) and can be viewed as an average seasonal profile that is common to all grouped items and αₜ comprises the scaling coefficients by item to scale up or down the seasonal profile according the items average sales level.

In the second step of the MDLM's specification, the values of and μₜ and αₜ can be assumed, on average, to sit around their values at the previous time point as follows:

$$( \begin{matrix}{μ}_{t} \\ {α}_{t}\end{matrix} ) = ( \begin{matrix}{μ}_{t - 1} \\ {α}_{t - 1}\end{matrix} ) + ( \begin{matrix}{e}^{g} {δ}_{1 t} \\ {e}^{h} {δ}_{2 t}\end{matrix} ) , \\ ( \begin{matrix}{δ}_{1 t} \\ {δ}_{2 t}\end{matrix} ) \sim [ 0 , {σ}^{2} ( \begin{matrix}G & 0 \\ 0 & H\end{matrix} ) ] ,$$

where δ₁ₜ and δ₂ₜ represent correlated jumps that lead to new level and seasonality coefficients in time given their past values; and e^{g} and e^{h} are the signal-to-noise ratios. This specification can be viewed as a prior distribution on the unknown parameter vectors at any time t,

$$p ( {μ}_{t} , {α}_{t} \vert g , h ) = N [ ( \begin{matrix}{μ}_{t - 1} \\ {α}_{t - 1}\end{matrix} ) , {o}^{′ 2} ( \begin{matrix}{e}^{g} G & 0 \\ 0 & {e}^{h} H\end{matrix} ) ] .$$

Propagating this dependence over all time points leads to two vector stochastic processes in time {μₜ,αₜ} whose smoothness is determined by the signal-to-noise ratios. For example, forcing g→−∞ leads to a constant or completely smooth local level process and increasing g leads to a very unsmooth or noisy process. Next the similarity of the individual item level process within {μₜ, αₜ} is determined by the prior cross-sectional correlation matrices G and H. In one extreme when the off-diagonal elements of these matrices are 1, all item level processes are fully correlated and become essentially the same; on the other extreme, when the off-diagonals are 0, all item level processes are fully independent of one another. It turns out that the specification of the parameters {g, h, G, H} can also be used to reduce the effective number of parameters in the MDLM.

For ease of exposition, in the following sections, the specification will refer to (g, h) instead of (e^{g}, e^{h}) and refer to them as loading parameters. Given these and the observed log-sales time series {Yₜ}, Kalman filters can be employed to estimate the time series {μₜ} and {αₜ} until the present, then produce forecasts for the future. The forecasts, however, are very sensitive to the choice of loadings and one way of get around this problem is to fit multiple MDLMs for different values of loading parameters on historical data to come up with a weighted-average or ensemble of multiple MDLMs. A related application, U.S. patent application Ser. No. 14/641,075, filed Mar. 6, 2015 incorporated herein by reference, describes an exemplary process that is referred to as off-line cross-validation. In a typical application, this cross-validatory step may involve running a Kalman Filter 26 times for each of 40 DLMs (i.e. 40 pairs of loading parameters). While such a technique produces great accuracy, it can also be extremely time consuming and it is not easily scalable to large sets of items. In addition, for items that do not sell as much as the high-selling items, some inaccuracy might be more tolerable.

A faster method of producing such a forecast is to perform cross-validation in real-time and on-line (that is, on the fly), as opposed to periodically executing an extremely time-consuming cross-validation procedure. Here one can rely on sequential learning techniques to update the weights of individuals MDLMs (each with a different value of loading parameters) as new forecasts are generated every week.

As noted before, multiple DLMs can be combined to produce better and more reliable forecasts. In the statistical terminology, this is referred to as model averaging where one tries to average across models with different loadings to lower uncertainty and create more reliable forecasts. More formally, model averaging leads to the marginal likelihood that does not depend on the values of (g,h),

p(Yₜ)=∫p(Yₜ|μₜ, αₜ)p(μₜ, αₜ|g, h)d(g, h)

In order to average over models sequentially and on-the-fly, the loadings, and ultimately the smoothness of the fitted time series, can vary with time as follows:

$$( \begin{matrix}{g}_{t} \\ {h}_{t}\end{matrix} ) = γ + ( \begin{matrix}{g}_{t - 1} \\ {h}_{t - 1}\end{matrix} ) + ( \begin{matrix}{ξ}_{1 t} \\ {ξ}_{2 t}\end{matrix} ) , where ( \begin{matrix}{ξ}_{1 t} \\ {ξ}_{2 t}\end{matrix} ) \sim N [ 0 , ( \begin{matrix}{τ}_{g}^{2} & 0 \\ 0 & {τ}_{h}^{2}\end{matrix} ) ]$$

As an aside, this type of modeling is more commonly referred to as log-stochastic volatility modeling in financial time series applications. With this third layer in place, Kalman filters are no longer used for sequential estimation. Instead, particle filtering methods are used in some embodiments.

Particle filtering (also known as sequential Monte Carlo) methods are a set of on-line posterior density estimation algorithms that estimate the posterior density by using sequential sampling techniques. Since the mid-1990s several particle filtering techniques have been devised. Some notable ones include sequential importance sampling (SIS), sequential importance resampling (SIRS) and the auxiliary particle filter (APF).

Sequential estimation in state-space models use recursions to propagate the following posterior distributions in time,

. . . p(xₜ₋₁|Yₜ₋₁)→p(xₜ₋₁|Yₜ)→p(xₜ|Yₜ) . . .

The basic MDLM model described above minus the log-stochastic volatility layer, happens to be in the standard state-space form, xₜ=(μₜ, αₜ) and it suffices to propagate the mean and covariance of these posterior distributions in time via the Kalman filter.

For general state-space models consisting of the following two layers,

Yₜ˜u(Yₜ|xₜ) and xₜ˜s(xₜ|xₜ₋₁)

Here, SIS represents the posterior distributions by samples which are propagated in time using importance sampling,

$$… \frac{1}{M} {\sum }_{k} δ ( {x}_{t - 1} - {x}_{t - 1}^{( k )} ) -> \frac{1}{M} {\sum }_{k} δ ( {x}_{t} - {x}_{t}^{( k )} ) -> \frac{1}{M} {\sum }_{k} {w}^{( k )} δ ( {x}_{t} - {x}_{t}^{( k )} ) …$$

where the second step involves sampling xₜ^{(k)}˜s(xₜ|xₜ₋₁^{(k)}) and

(xₜ₋₁^{(k)}, xₜ^{(k)})˜p(xₜ₋₁, xₜ|Yₜ₋₁) leads to xₜ^{(k)}˜p(xₜ|Yₜ₋₁).

This leads to the following equation for the weights for importance sampling:

w^{(k)}=p(xₜ|Yₜ)/p(xₜ|Yₜ₋₁)∝c(Yₜ|xₜ)

The problem with SIS is that sampling errors accumulate over time and after a few sequential steps the particles become degenerate. Particle impoverishment makes SIS a very inefficient procedure, i.e., a large number of samples are required to have any meaningful estimates and this leads to large computational overhead.

A resampling step is can be used to correct this problem with SIS, where M samples are drawn with probabilities proportional to the weights w^{(k)}, following which the weights are reset to 1/M. This leads to the so-called sequential importance resampling (SIRS) procedure.

An algorithm called particle learning includes a resample-propagate framework that directly samples from the particle approximation to the joint posterior distribution of states and conditional sufficient statistics for fixed parameters in a fully adapted resample-propagate-sample framework. These algorithms assume particles:

{θₜ₋₁^{(k)}, wₜ₋₁^{(k)}}ₖ₌₁^{M} where θₜ₋₁=(gₜ₋₁, hₜ₋₁, mₜ₋₁, Cₜ₋₁) & rewrites it as follows:

f(xₜ, θₜ₋₁|Yₜ)∝f(xₜ|θₜ₋₁, Yₜ)f(θₜ₋₁|Yₜ)∝f(xₜ|θₜ₋₁)f(Yₜ|θₜ₋₁)f(θₜ₋₁| . . . )

The idea here is to look ahead and resample. First, with the following relationship before propagation:

wₜ^{(k)}∝f(Yₜ|\tilde{θ}ₜ₋₁^{(k)})

Thereafter, repeat the following steps:

(1) Resample: {\tilde{θ}ₜ₋₁^{(k)}}ₖ₌₁^{M} with the weights wₜ^{(k)}∝f(Yₜ|\tilde{θ}ₜ₋₁^{(k)})

(2) Propagate state vectors through Kalman Filtering: xₜ^{(k)}˜f(xₜ|\tilde{θ}ₜ₋₁^{(k)}, Yₜ), then {mₜ, Cₜ}^{(k)}

(3) Sample: {gₜ, hₜ}^{(k)}˜f(gₜ, hₜ|Yₜ, {mₜ, Cₜ}^{(k)})

The result of the above is that the weights of the various DLMs are run through various DLMs to create a resampling. Thereafter state vectors are propagated through the DLMs. Thereafter, the sampling step determines a forecast for the near future. The weights of “bad” (i.e., not as accurate) DLMs become lower as the process is repeated, resulting in more accurate parameters and DLMs being used for future resample-propagate steps. In such a manner, the look-ahead period can be relatively short (approximately 6 to 13 weeks in some embodiments). Thus, the weights, parameters, and DLMs used in the summer can be different from the weights, parameters, and DLMs used during the holiday season.

In terms of forecasting, the weights of the DLMs can be used to create an overall sales forecast for SKUs within a cluster. Thereafter, the sales forecast can be used to order SKUs within a cluster for the retailer/distributor.

Running the above particle learning algorithm cause the variables gₜ and hₜ to approach infinity. Thus, to achieve T-step ahead forecasts, weights can be calculated based on the T-step ahead predictive distribution:

f(Y_{t+T-1}|, gₜ, hₜ)=N(F_{t+T-1}mₜ₋₁, F_{t+T-1}(Cₜ₋₁+κW(gₜ,gₜ))F′_{t+T-1}+Vₜ)

f(Y_{t-T-1}|gₜ₋₁, hₜ₋₁)=∫f(Y_{t+T-1}|gₜ, hₜ)dF(gₜ, hₜ|gₜ₋₁, hₜ₋₁)

where κ=Σₛ₌₀^{T-1} exp(sγ).

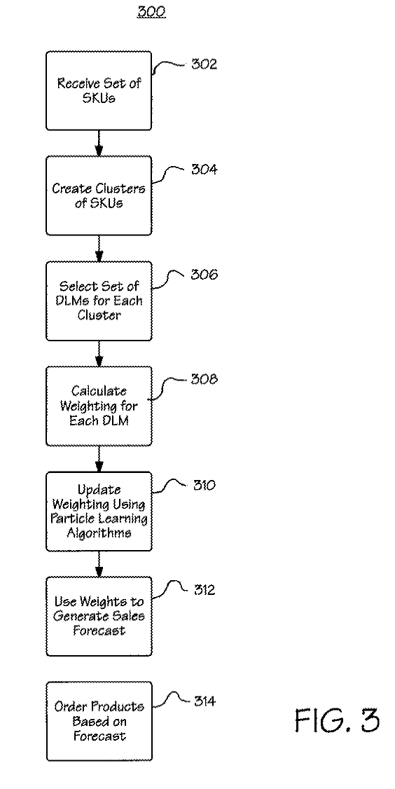

Now that the mathematical theory has been set forth, the operation of some embodiments will be discussed with reference to FIG. 3, a flowchart illustrating the operation of a method 300 of forecasting using particle learning. Method 300 is merely exemplary and is not limited to the embodiments presented herein. Method 300 can be employed in many different embodiments or examples not specifically depicted or described herein. In some embodiments, the procedures, the processes and/or the activities of method 300 can be performed in the order presented. In other embodiments, the procedures, the processes, and/or the activities of method 300 can be performed in any other suitable order. In still other embodiments, one or more of the procedures, the processes, and/or the activities of method 300 can be combined or skipped. In some embodiments, method 300 can be implemented by computer system 100 (FIG. 1).

A set of SKUs are presented to an embodiment to generate a forecast (block 302). Clusters can be formed that group similar SKUs into clusters for forecasting purposes (block 304). The grouping for forecasting purposes can be accomplished in a variety of different manners. Exemplary manners are presented in the following patent applications, incorporated herein by reference: U.S. patent application Ser. No. 14/638,637 and U.S. patent application Ser. No. 14/638,694, both filed Mar. 4, 2015. Other clustering algorithms also can be used. Thereafter, an embodiment selects a set of Dynamic Linear Models for each of the clusters (block 306). Examples of the types of DLMs that can be performed are detailed above. Other DLMs also can be used. In some embodiments, up to 40 DLMs might be used.

Then, a sequential learning algorithm is used to create a weighting of each dynamic linear model in the set of dynamic linear models (block 308). The weightings are updated using a particle learning algorithm (block 310).

As described in greater detail above, the particle learning algorithm can use the steps of resampling, propagating a set of state vectors, and sampling to determine parameters for the set of dynamic linear models.

After the weights of each DLM are determined in a training procedure, the weights are then used to calculate the forecast for the cluster of SKUs (block 312). Products can then be ordered based on the forecast (block 314).

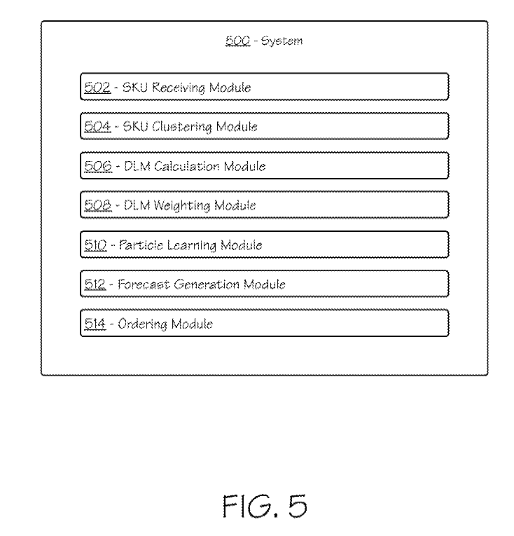

Turning ahead in the figures, FIG. 5 illustrates a block diagram of a system 500 that is capable of performing disclosed embodiments. System 500 is merely exemplary and is not limited to the embodiments presented herein. System 500 can be employed in many different embodiments or examples not specifically depicted or described herein. In some embodiments, certain elements or modules of system 500 can perform various procedures, processes, and/or acts. In other embodiments, the procedures, processes, and/or acts can be performed by other suitable elements or modules.

In a number of embodiments, system 500 can include SKU receiving module 502. In certain embodiments, SKU receiving module 502 can perform block 302 (FIG. 3) of receiving a set of SKUs.

In a number of embodiments, system 500 can include SKU clustering module 504. In certain embodiments, SKU clustering module 504 can perform block 304 (FIG. 3) of creating clusters of SKUs.

System 500 can include DLM calculation module 506. In certain embodiments, DLM calculation module 506 can perform block 306 of calculating DLMs for each cluster.

System 500 can include DLM weighting module 508. In certain embodiments, DLM weighting module 508 can perform block 308 of calculating a weighting for each DLM.

System 500 can include particle learning module 510. In certain embodiments, forecast creation module 510 can perform block 310 of using particle learning algorithms to update DLM weighting.

System 500 can include forecast generation module 512. In certain embodiments, ordering module 512 can perform block 312 of generating a forecast for a cluster of SKUs based on the weights of each DLM.

System 500 can include ordering module 514. In certain embodiments, ordering module 514 can perform block 314 of ordering products based on the created forecast.

Although the above embodiments have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 can be modified, and that the foregoing discussion of certain of these embodiments does not necessarily represent a complete description of all possible embodiments. For example, one or more of the procedures, processes, or activities of FIGS. 1-5 can include different procedures, processes, and/or activities and be performed by many different modules, in many different orders.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method comprising:
receiving a set of stock keeping units (SKUs);
creating a plurality of clusters of SKUs from the set of SKUs;
choosing a set of dynamic linear models and associated parameters to create a forecast for each cluster in the plurality of clusters of SKUs;
using a sequential learning algorithm to create a weighting of each dynamic linear model in the set of dynamic linear models;
periodically updating the weighting of each dynamic linear model using a particle learning algorithm;
generating a sales forecast for each cluster of SKUs in the plurality of clusters of SKUs;
and
ordering inventory based on the sales forecast for each cluster of SKUs in the plurality of clusters of SKUs.

2. The method of claim 1 wherein the particle learning algorithm comprises:
performing a resampling the set of dynamic linear models using a set of weights;
propagating a set of state vectors through the set of dynamic linear models based on the resampling; and
performing a sampling to determine parameters for the set of dynamic linear models.

3. The method of claim 2 wherein:
the resampling uses the formula:
{\tilde{θ}ₜ₋₁^{(k)}{ₖ₌₁^{M}
with the weights:
wₜ^{(k)}∝f(Yₜ|\tilde{θ}ₜ₋₁^{(k)}).

4. The method of claim 3 wherein:
the resampling uses a time period of six weeks to determine weights.

5. The method of claim 2 wherein:
propagating state vectors comprises calculating the state vectors as follows:
xₜ^{(k)}˜f(xₜ|\tilde{θ}ₜ₋₁^{(k)}, Yₜ), then {mₜ, Cₜ}^{(k)}.

6. The method of claim 2 wherein:
performing a sampling to determine parameters comprises calculating parameters gₜ and hₜ as follows:
{gₜ, hₜ}^{(k)}˜f(gₜ, hₜ|Yₜ, {mₜ, Cₜ}^{(k)}).

7. The method of claim 1 wherein:
generating a sales forecast for each cluster of SKUs comprises calculating a weighted average using the weighting of each dynamic linear model.

8. A system comprising:
a user input device;
a display device;
one or more processing modules; and
one or more non-transitory storage modules storing computing instructions configured to run on the one or more processing modules and perform the acts of:
receiving a set of stock keeping units (SKUs);
creating a plurality of clusters of SKUs from the set of SKUs;
choosing a set of dynamic linear models and associated parameters to create a forecast for each cluster in the plurality of clusters of SKUs;
using a sequential learning algorithm to create a weighting of each dynamic linear model in the set of dynamic linear models;
periodically updating the weighting of each dynamic linear model using a particle learning algorithm;
generating a sales forecast for each cluster of SKUs in the plurality of clusters of SKUs; and
ordering inventory based on the sales forecast for each cluster of SKUs in the plurality of clusters of SKUs.

9. The system of claim 8 wherein the particle learning algorithm comprises:
performing a resampling the set of dynamic linear models using a set of weights;
propagating a set of state vectors through the set of dynamic linear models based on the resampling; and
performing a sampling to determine parameters for the set of dynamic linear models.

10. The system of claim 9 wherein:
the resampling uses the formula:
{\tilde{θ}ₜ₋₁^{(k)}{ₖ₌₁^{M}
with the weights:
wₜ^{(k)}∝f(Yₜ|\tilde{θ}ₜ₋₁^{(k)}).

11. The system of claim 10 wherein:
the resampling uses a time period of six weeks to determine weights.

12. The system of claim 9 wherein:
propagating state vectors comprises calculating the state vectors as follows:
xₜ^{(k)}˜f(xₜ|\tilde{θ}ₜ₋₁^{(k)}, Yₜ), then {mₜ, Cₜ}^{(k)}.

13. The system of claim 9 wherein:
performing a sampling to determine parameters comprises calculating parameters gₜ and hₜ as follows:
{gₜ, hₜ}^{(k)}˜f(gₜ, hₜ|Yₜ, {mₜ, Cₜ}^{(k)}).

14. The system of claim 8 wherein:
generating a sales forecast for each cluster of SKUs comprises calculating a weighted average using the weighting of each dynamic linear model.

15. At least one non-transitory memory storage module having computer instructions stored thereon executable by one or more processing modules to:
receive a set of stock keeping units (SKUs);
create a plurality of clusters of SKUs from the set of SKUs;
choose a set of dynamic linear models and associated parameters to create a forecast for each cluster in the plurality of clusters of SKUs;
use a sequential learning algorithm to create a weighting of each dynamic linear model in the set of dynamic linear models;
periodically update the weighting of each dynamic linear model using a particle learning algorithm;
generate a sales forecast for each cluster of SKUs in the plurality of clusters of SKUs;
and order inventory based on the sales forecast for each cluster of SKUs in the plurality of clusters of SKUs.

16. The at least one non-transitory memory storage module of claim 15 wherein the particle learning algorithm comprises:
performing a resampling the set of dynamic linear models using a set of weights;
propagating a set of state vectors through the set of dynamic linear models based on the resampling; and
performing a sampling to determine parameters for the set of dynamic linear models.

17. The at least one non-transitory memory storage module of claim 16 wherein:
the resampling uses the formula:
{\tilde{θ}ₜ₋₁^{(k)}{ₖ₌₁^{M}
with the weights:
wₜ^{(k)}∝f(Yₜ|\tilde{θ}ₜ₋₁^{(k)}).

18. The at least one non-transitory memory storage module of claim 16 wherein:
the resampling uses a time period of six weeks to determine weights.

19. The at least one non-transitory memory storage module of claim 18 wherein:
propagating state vectors comprises calculating the state vectors as follows:
xₜ^{(k)}˜f(xₜ|\tilde{θ}ₜ₋₁^{(k)}, Yₜ), then {mₜ, Cₜ}^{(k)}.

20. The at least one non-transitory memory storage module of claim 15 wherein:
wherein performing a sampling to determine parameters comprises calculating parameters gₜ and hₜ as follows:
{gₜ, hₜ}^{(k)}˜f(gₜ, hₜ|Yₜ, {mₜ, Cₜ}^{(k)}).

21. The at least one non-transitory memory storage module of claim 15 wherein:
generating a sales forecast for each cluster of SKUs comprises calculating a weighted average using the weighting of each dynamic linear model.
